(19) United States
(12) Patent Application Publication
(10) Pub. No.: US 2021/0039679 A1
(43) Pub. Date: Feb. 11, 2021

(54) APPARATUS FOR CONTROLLING AN AUTONOMOUS VEHICLE, SYSTEM INCLUDING THE SAME, AND METHOD FOR THE SAME

(71) Applicants: HYUNDAI MOTOR COMPANY, SEOUL (KR); KIA MOTORS CORPORATION, SEOUL (KR)

(72) Inventors: Su Hong CHAE, Hwaseong-si (KR); Dong Hwi LEE, Seongnam-si (KR)

(73) Assignees: HYUNDAI MOTOR COMPANY, SEOUL (KR); KIA MOTORS CORPORATION, SEOUL (KR)

(21) Appl. No.: 16/782,884

(22) Filed: Feb. 5, 2020

(30) Foreign Application Priority Data
Aug. 9, 2019 (KR) 10-2019-0097724

(51) Int. Cl. B60W 60/00; G05D 1/00; B60W 40/13

(52) U.S. Cl. CPC B60W 60/0053; B60W 30/18163; B60W 40/13; B60W 60/0015; G05D 1/0061; B60W 2510/22; B60W 2520/105; B60W 2520/10; B60W 2510/0657; B60W 2510/0638; B60W 2530/10; B60W 2530/16; G05D 2201/0213; B60W 2552/40; G05D 1/0088

(57) ABSTRACT

An apparatus for controlling an autonomous vehicle, a system including the same, and a method for the same are provided. The apparatus for controlling the autonomous vehicle includes a processor to perform a control operation, to acquire a weight of the autonomous vehicle in real time, and to provide an autonomous driving function based on the weight of the autonomous vehicle, and a storage to store the weight of the autonomous vehicle and information regarding the autonomous driving functions corresponding to the weight of the autonomous vehicle.

### CROSS-REFERENCE TO RELATED APPLICATION

The present application claims priority to and the benefit of Korean Patent Application No. 10-2019-0097724, filed on Aug. 09, 2019, which is incorporated herein by reference in its entirety.

### TECHNICAL FIELD

The present disclosure relates to an apparatus for controlling an autonomous vehicle, a system including the same, and a method for the same, and more particularly to a technology of estimating the weight of the vehicle and of reflecting the weight of the vehicle in autonomous driving control.

### BACKGROUND

The statements in this section merely provide background information related to the present disclosure and may not constitute prior art.

Recently, an autonomous driving system has been installed in a vehicle to automatically perform driving without involving a driver in driving so as to improve the convenience of the driver. In this case, all logic to control a vehicle is fundamentally performed based on the mass (weight) of a vehicle in terms of vehicle dynamics. Accordingly, the weight of the vehicle may be exactly measured or estimated for the safety control of the vehicle.

However, conventionally, the vehicle control is performed using a vehicle weight value set at the initial stage without separately estimating the variation in the weight of the vehicle.

Accordingly, when many passengers get on a vehicle or a large amount of baggage is loaded on the vehicle, or the weight value set at the initial stage is different from an actual vehicle weight, autonomous driving controllers may erroneously operate and an accident may be caused due to the erroneous operation of the autonomous driving controllers.

### SUMMARY

An aspect of the present disclosure provides an apparatus for controlling an autonomous vehicle, a system including the same, and a method for the same, capable of estimating the weight of the autonomous vehicle to be reflected in vehicle control or differently providing an autonomous driving function based on the weight of the autonomous vehicle, thereby improving the safety of the autonomous driving function.

According to an aspect of the present disclosure, an apparatus for controlling an autonomous vehicle may include a processor that performs a control operation to acquire a weight of the autonomous vehicle in real time and to provide an autonomous driving function based on the weight of the autonomous vehicle; and a storage to store the weight, which is acquired by the processor, of the autonomous vehicle and information on autonomous driving functions provided for weights of the autonomous vehicle.

In some forms of the present disclosure, the processor may estimate the weight of the autonomous vehicle based on a measurement result of a suspension height.

In some forms of the present disclosure, the processor may estimate the weight of the autonomous vehicle through vehicle dynamics calculation based on a vehicle acceleration, a vehicle speed, an engine torque, and an engine shaft angular speed.

In some forms of the present disclosure, the processor may calculate driving force of the autonomous vehicle using the engine torque and the engine shaft angular speed, and estimate the weight of the autonomous vehicle by using the driving force, a vehicle mass, the vehicle acceleration, an air resistance coefficient, and a rolling resistance.

In some forms of the present disclosure, the processor may estimate the weight of the autonomous vehicle based on a braking distance resulting from a required deceleration of a vehicle.

In some forms of the present disclosure, the processor may classify weight grades based on weights of autonomous vehicle and road frictions.

In some forms of the present disclosure, the processor may perform the autonomous driving function by activating the autonomous driving function and changing a control coefficient, when the weight of the autonomous vehicle is equal to or less than a preset first reference value.

In some forms of the present disclosure, the processor may limitedly perform the autonomous driving function when the weight of the autonomous vehicle is greater than the preset first reference value and smaller than a second reference value.

In some forms of the present disclosure, the processor may perform at least one of control of lowering a maximum limit speed, control of increasing a distance from a front vehicle, control of deactivating a lane changing function, control of deactivating an overtaking function, and/or control of incresing a deceleration based on a road curvature to limitedly perform the autonomous driving function.

In some forms of the present disclosure, the processor may deactivate the autonomous driving function, when the weight of the autonomous vehicle is greater than the second reference value.

In some forms of the present disclosure, the processor may transfer control authority to a driver or control autonomous driving such that danger bcomes reduced, when the weight of the autonomous vehicle is greater than the second reference value during the autonomous driving function.

According to another aspect of the present disclosure, a vehicle system may include a sensing device to sense information for estimating a weight of a vehicle, and an autonomous vehicle control device to acquire the weight of the vehicle based on the information received from the sensing device in real time and to differently provide an autonomous driving function based on the weight of the vehicle.

In some forms of the present disclosure, the sensing device may include a mass measurement sensor to measure the weight of the vehicle, or a height measurement sensor to measure a suspension height of the vehicle.

In some forms of the present disclosure, the autonomous vehicle control device may estimate the weight of the vehicle based on a difference between a suspension height measured when the vehicle is stopped and a suspension height set when the vehicle is designed.

In some forms of the present disclosure, a method for controlling an autonomous vehicle may include acquiring a weight of the autonomous vehicle in real time, and providing an autonomous driving function based on the weight of the autonomous vehicle.

In some forms of the present disclosure, the acquiring of the weight of the autonomous vehicle in real time may include estimating the weight of the autonomous vehicle based on a measurement result of a suspension height or a braking distance resulting from a required deceleration of a vehicle.

In some forms of the present disclosure, the acquiring of the weight of the autonomous vehicle in real time may include estimating the weight of the autonomous vehicle through vehicle dynamics calculation based on a vehicle acceleration, a vehicle speed, an engine torque, and an angular speed of an engine shaft.

In some forms of the present disclosure, the providing of the autonomous driving function may include performing the autonomous driving function by activating the autonomous driving function and changing a control coefficient, when the weight of the vehicle is equal to or less than a preset first reference value, limitedly performing the autonomous driving function when the weight of the vehicle is greater than a preset first reference value and less than a second reference value, and deactivating the autonomous driving function when the weight of the vehicle is greater than the second reference value.

In some forms of the present disclosure, the limitedly performing of the autonomous driving function may include performing at least one of control of lowering a maximum limit speed, control of increasing a distance from a front vehicle, control of deactivating a lane changing function, control of deactivating an overtaking function, and/or control of incresing a deceleration based on a road curvature.

Further ares of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating the components of a vehicle system including an apparatus for controlling an autonomous vehicle, in one form of the present disclosure;

FIG. 2 is a view illustrating that a weight measurement sensor is mounted in a vehicle, in one form of the present disclosure;

FIG. 3 is a view illustrating a method for measuring the weight of the vehicle, in one form of the present disclosure;

FIG. 4 is a flowchart illustrating the method for controlling the autonomous vehicle, in one form of the present disclosure; and

FIG. 5 is a block diagram illustrating a computing system, in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing some forms of the present disclosure, a detailed description of well-known features or functions will be ruled out in order not to unnecessarily obscure the gist of the present disclosure.

In describing some forms of the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses a technology of estimating and learning a real mass (weight) of the vehicle and reflecting the real mass in the control logic of the vehicle, thereby steadily maintaining the control performance even if the vehicle has a large mass, and of limitedly providing an autonomous driving function, thereby controlling the autonomous driving function to safely, effectively, and normally operate.

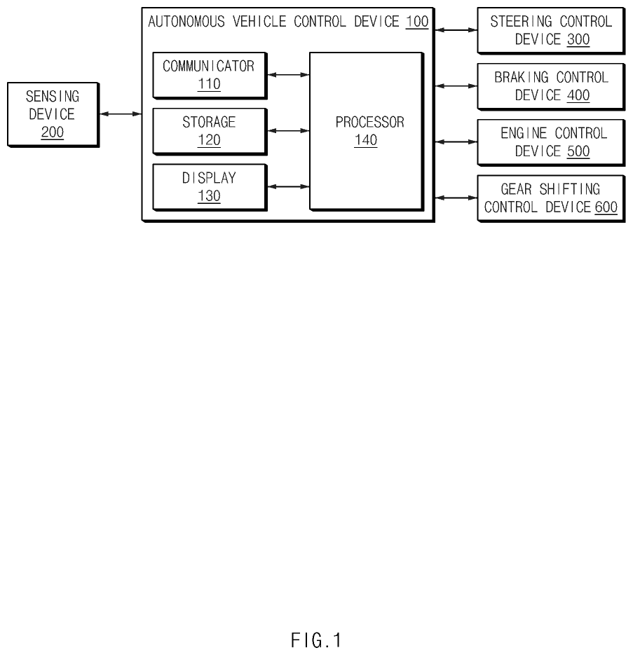

Hereinafter, some forms of the present disclosure will be described in detail with reference to FIGS. 1 to 5.

FIG. 1 is a block diagram illustrating the components of a vehicle system including an apparatus (hereinafter, referred to as an “autonomous vehicle control device”) for controlling an autonomous vehicle, in some forms of the present disclosure.

Referring to FIG. 1, in some forms of the present disclosure, the vehicle system may include an autonomous vehicle control device 100, a sensing device 200, a steering control device 300, a braking control device 400, an engine control device 500, and a gear shifting control device 600.

The autonomous vehicle control device 100 may a control operation to acquire a weight of a vehicle in real time and to differentially provide an autonomous driving function based on the weight of the autonomous vehicle. The autonomous vehicle control device 100 may estimate the weight of the vehicle based on the difference between a suspension height measured when the vehicle is stopped and a suspension height set when the vehicle is designed.

The autonomous vehicle control device 100 may include a communicator 110, a storage 120, a display 130, and a processor 140.

The communicator 110 is a hardware device implemented with various electronic circuits to transmit and receive a signal through wireless or wired connection. According to the present disclosure, the communicator 110 may make in-vehicle communication through controller area network (CAN) communication or local interconnect network (LIN) communication and may communicate with the sensing device 200, the steering control device 300, the braking control device 400, the engine control device 500, and the gear shifting control device 600.

The storage 120 may store the sensing result of the sensing device 200 and the weight, which is estimated by the processor 140, of the vehicle, a grade based on the weight, and information on an activated autonomous driving function. In addition, the storage 120 may store an algorithm to estimate the weight of the vehicle in advance. The storage 120 may be implemented with at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, and/or an optical disk-type memory.

The display 130 may display an autonomous driving operating state (function limited) based on the weight grade of the vehicle which is estimated and applied in real time. The display 130 may be implemented with a head up display (HUD), a cluster, an audio video navigation (AVN), or the like. In addition, the display 130 may include at least one of a liquid crystal display (LCD), a thin film transistor-liquid crystal display (TFT LCD), a light emitting diode (LED) display, an organic light-emitting diode (OLED) display, an active matrix OLED (AMOLED) display, a flexible display, a bended display, and/or a third dimension (3D) display. Among them, some displays may be implemented with transparent displays configured in a transparent type or a light translucence type such that the displays are viewed from the outside. In addition, the display 130 is implemented with a touchscreen including a touch panel to be used as an input device in addition to an output device.

The processor 140 may be electrically connected with the communicator 110, the storage 120, and the display 130, may electrically control each component, and may be an electric circuit that executes software commands. Accordingly, the processor 140 may perform various data processing and calculation, to be described below.

The autonomous vehicle control device 140 may a control operation to acquire a weight of a vehicle in real time and to differentially provide an autonomous driving function based on the weight of the autonomous vehicle.

The processor 140 may estimate the weight of the autonomous vehicle based on a measurement result of the spension height, estimate the weight of the vehicle through vehicle dynamics calculation based on a vehicle acceleration, a vehicle speed, an engine torque, and an engine shaft angular speed, or estimate the weight of the vehicle based on a braking distance resulting from a required deceleration of a vehicle. In this case, the processor 140 may estimate the weight of the vehicle through a learned algorithm previously stored. In addition, the processor 140 may calculate the driving force of the vehicle by using an engine torque and an engine shaft angular speed, and may estimate the weight of the vehicle by using the driving force, a vehicle mass, the vehicle acceleration, an air resistance coefficient, and a rolling resistance.

In this case, the learned algorithm may be defined as an algorithm for learning the weight value of the vehicle with respect to each vehicle suspension height, for learning the weight value of the vehicle based on a vehicle acceleration, a seped, an engine torque, or an engine shaft angular speed, or for learning the weight value of the vehicle with respect to each braking distance.

Accordingly, the processor 140 may calculate the vehicle suspension height using the learned algorithm, input the vehicle suspension height as an input value of the learned algorithm, and acquire the weight value of the vehicle.

The processor 140 may classify weight grades based on the weight of the vehicle and the road friction, and the weight grades may be classified into a normal grade, a function liitation grade, and an abnormal grade.

The processor 140 may perform the autonomous driving function by activating the autonomous driving function and changing a control coefficient, when the weight of the autonomous vehicle is equal to or less than a preset first reference value

In addition, the processor 140 may limitedly perform the autonomous driving function when the weight of the vehicle is greater than a preset first reference value and smaller than a second reference value. In this case, the second reference value may be set to be greater than the first reference value, and the first reference value and the second reference value may be experimentally obtained and may be previously stored.

The processor 140 may perform at least one of control of lowering a maximum limit speed, control of increasing a distance from a front vehicle, control of deactivating a lane changing function, control of deactivating an overtaking function, and/or control of increasing a deceleration based on a road curvature, to limitedly perform the autonomous driving function.

The processor 140 may deactivate the autonomous driving function, when the weight of the autonomous vehicle is greater than the second reference value, and may transfer control authority to a driver or control autonomous driving such that danger becomes reduced, when it is determined that the weight of the autonomous vehicle is greater than the second reference value during the autonomous driving function.

The sensing device 200 may include at least one sensor, such as a mass measurement sensor to measure the weight of the vehicle, a height measurement sensor to measure the suspension height of the vehicle, a sensor to measure a required speed or acceleration of the vehicle. In addition, the sensor device 200 may include an ultrasonic sensor, a radar, a camera, a laser scanner and/or a corner radar, a lidar, an acceleration sensor, a yaw rate sensor, a torque measurement sensor and/or a wheel speed sensor, or a steering angle sensor to measure the acceleration and the speed of the vehicle.

The steering control device 300 may be configured to control the steering angle of the vehicle, and may include a steering wheel, an actuator operating together with the steering wheel, and a controller to control the actuator. The steering control device 300 may be implemented with a motor driven power steering (MDPS).

The braking control device 400 may be configured to control the braking of the vehicle, and may include a controller to control a brake. The braking control device 400 may be implemented with Electronic Stability Control (ESC).

The engine control device 500 may be configured to control the engine driving of the vehicle, and may include a controller to control the speed of the vehicle. The engine control device 500 may be implemented with an Engine Management System (EMS).

The gear shifting control device 600 may be configured to control the gear shifting of the vehicle, implemented with a Shift by Wire Control Unit (SCU), and perform a target gearshift stage (P/R/N/D).

As described above, according to the present disclosure, the weight of the vehicle is exactly estimated in real time, and the autonomous driving function is limited or deactivated based on the weight of the vehicle, thereby streadily maintaining the performance of the autonomous driving function to effectively and safely control the autonomous driving even if the vehicle has a large weight.

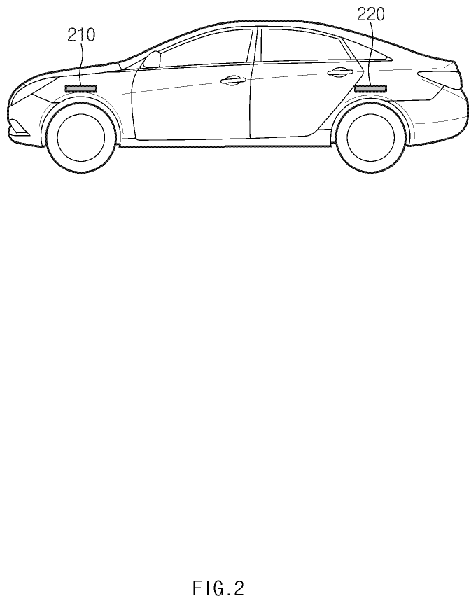

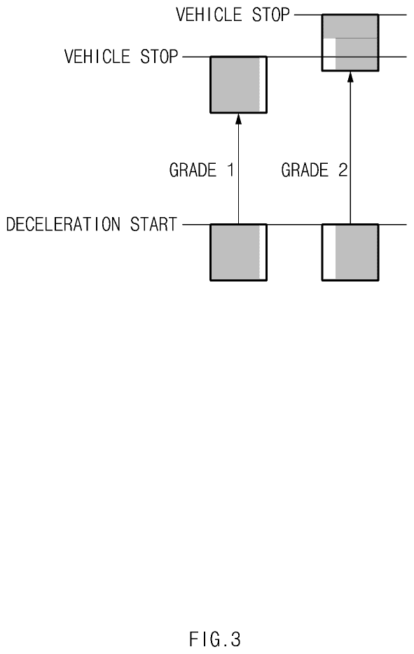

Hereinafter, a method for estimating the weight of the vehicle will be described with reference to FIGS. 2 and 3. FIG. 2 is a view illustrating that a weight measurement sensor is mounted in the vehicle, in some forms of the present disclosure, and FIG. 3 is a view illustrating a method for measuring the weight of the vehicle, in some forms of the present disclosure.

First, the autonomous vehicle control device 100 may estimate the weight of the vehicle based on the measurement values of the weight measurement sensor or the suspension height measurement sensor.

As illustrated in FIG. 2, four weight measurement sensors are mounted in suspension parts of the vehicle, and measure a weight value by the weight measurement sensor when the vehicle is stopped, and store the weight value.

Alternatively, a height measurement sensor may be mounted to measure the suspension height of the suspension part, the height changed due to the self-weight in relation to a tolerance, which is measured when the vehicle is stopped or designed, may be measured, and the self-weight of the vehicle may be estimated by using the changed height value.

Second, the autonomous vehicle control device 100 may estimate the weight of the vehicle through the vehicle dynamics calculation. In other words, the autonomous vehicle control device 100 may estimate the weight of the vehicle by using an acceleration, a speed, an engine torque, or an engine shaft angular speed.

### Equation 1

$${ma}_{x} = {F}_{tractive} - {F}_{air} - {F}_{rolling} \\ {ma}_{x} = {F}_{tractive} - \frac{1}{2} {μ}_{air} {v}_{x}^{2} - {F}_{rolling} \\ {F}_{tractive} = {ma}_{x} + \frac{1}{2} {μ}_{air} {v}_{x}^{2} + {F}_{rolling} \qquad Equation 1$$

In this case, F_{ractive} refers to driving force, m refers to the weight of the vehicle, μₐᵢᵣ refers to an air resistance coefficience, and the F_{rolling} refers to rolling resistance. In this case, the driving force F_{ractive} may be calculated based on a gear ratio of elements included in a power train as in Equation 2.

$${F}_{tractive} = \frac{{T}_{e} \cdot {w}_{e}}{{v}_{x}} \qquad Equation 2$$

In this case, Tₑ refers to an engine torque, We refers to an engine shaft angular speed, and Vₓ is a vehicle speed. In other words, the autonomous vehicle control device 100 may acquire driving force based on vehicle information.

Accordingly, the autonomous vehicle control device 100 may estimate the weight of the vehicle through a recursive least square (RLS) by substituting Equation 2 into Equation 1.

Third, the autonomous vehicle control device 100 may estimate the weight of the vehicle by the braking distance. Referring to FIG. 3, the autonomous vehicle control device 100 may calculate the braking distance resulting from the required deceleration of the vehicle based on coordinate values of the vehicle, which are obtained through a precise positioning technology.

In addition, the autonomous vehicle control device 100 may estimate a grade based on the weight of the vehicle and the friction with the road based on a stop distance resulting from the speed and the acceleration identified by using an experimental value in a development stage.

In this case, when the weight of the vehicle is increased, normal force and intertia are increased. Accordingly, as the weight of the vehicle is increased, the braking distance has to be increased, such that the vehicle is stopped only by constant frictional force generated between a brake drum and a lining.

Hereinafter, an example of providing an autonomous driving function for each grade based on the vehicle weight will be described with reference to Table 1.

TABLE 1

| | Autonomous Driving | Sensing and |
|---|---|---|
| Weight | Function Operating | Determination during |
| Grade | Condition | Autonomous Driving |
| Normal | Function activation is | Normal operation and |
| Grade | possible and control | control coefficient is |
| (First | coefficient is variable | variable |
| Grade) | | |
| Function | Only warning function | Only warning function |
| limitation | and limitation function | and limitation function |
| grade | activated | activated |
| {Second | | |
| grade} | | |
| Abnormal | Warning and autonomous | Warning, driver control |
| grade(Third | driving function | authority transferred, |
| grade) | deactivated | and strategy of |
| | | minimizing danger |
| | | performed |

First, in the case of the normal grade (first grade), the autonomous vehicle control device 100 may perform a control operation such that all autonomous driving functions are normally used. In addition, the autonomous vehicle control device 100 may variously change coefficient values for longitudinal control and transversal control if necessary.

For example, in the case of P control, the weight is classified even at the normal grade, so the autonomous driving control is performed using the coefficient value A within the duration of [0] ms to [t1] ms, and using the coefficient value B the duration of [t1, t2] ms.

When the weight grade of the vehicle is the function limitation gade (second grade), the autonomous vehicle control device 100 may provide only a portion of the autonomous driving function.

For example, at the function limitation grade, the autonomous vehicle control device 100 may lower the maximum limit speed, increase the distance from the front distance, deactivate the lane changing function, deactive the overtaking function, or increase the deceleration based on the curvature of the road.

In addition, when the vehicle grade is the abnormal grade (third grade), the autonomous vehicle control device 100 blocks the autonomous driving function from being activated. In addition, when the abnormal grade is determined during the autonomous driving operation, warning may be performed, the control authority may be transferred to the driver, or a strategy of minimizing a danger may be performed. In this case, the strategy of minimizing the danger include a control operation performed in such a manner that a dangerous situation is not caused.

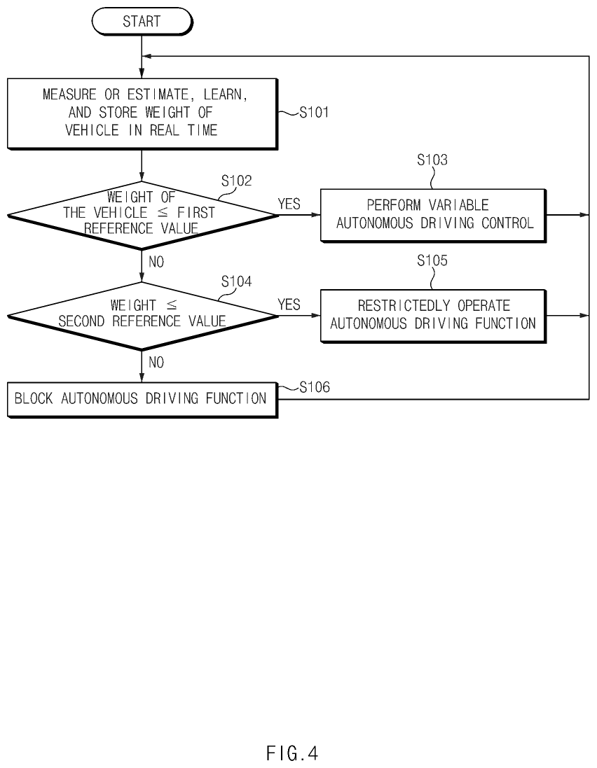

Hereinafter, the method for controlling the autonomous vehicle, in some forms of the present disclosure will be described with reference to FIG. 4. FIG. 4 is a flowchart illustrating the method for controlling the autonomous vehicle, in some forms of the present disclosure.

The following description will be made on the assumption that the autonomous vehicle control device 100 of FIG. 1 performs a process of FIG. 4. In addition, in the following description made with reference to FIG. 4, it may be understood that the operation described as being performed by the autonomous vehicle control device 100 is controlled by the processor 140 of the autonomous vehicle control device 100.

Referring to FIG. 4, the autonomous vehicle control device 100 measures or estimates, learns, and stores the weight of the vehicle in real time (S101). In this case, the autonomous vehicle control device 100 may measure the weight of the vehicle based on the weight measurement sensore, estimate the weight of the vehicle through the vehicle dynamics calculation, or may estimate the weight of the vehicle based on a braking distance. In addition, the autonomous vehicle control device 100 may be defined as an algorithm of tranining the estimation result of the weight of the vehicle using the learned algorithm.

The autonomous vehicle control device 100 determines whether the measured or estimated weight of the vehicle is equal to or less than a preset first reference value (S102). When the measured or estimated weight of the vehicle is equal to or less than the preset first reference value, variable autonomous driving control is performed by changing the control coefficient (S103). In this case, the control coefficient may include a longitudinal control coefficient and a transversal control coefficient.

Meanwhile, when the measured or estimated weight of the vehicle is greater than the preset first reference value, the autonomous vehicle control device 100 determines whether the masured or estimated weight of the vehicle is equal to or less than a preset second reference value (S104). In this case, the second reference value may be set to be greater than the first reference value, and the first reference value and the second reference value may be experimentally obtained and may be previously stored.

When the masured or estimated weight of the vehicle is equal to or less than the preset second reference value, the autonomous vehicle control device 100 limitedly performs the autonomous driving function (S105). When the masured or estimated weight of the vehicle is greater than the preset second reference value, the autonomous vehicle control device 100 may block the autonomous driving function for safe driving because the vehicle has a large weight (S106). In this case, the limited autonomous driving function may include lowering the maximum limit speed, increasing the distance from a front distance, deactivating a lane changing function, deactivating an overtaking function, and/or increasing a deceleration based on a road curvature.

As described above, in some forms of the present disclosure, the weight of the vehicle vehicle, which is varied depending on the number of passengers and an amount of baggage, is exactly estimated, and the autonomous driving function is limited or activated depending on the variation in the weight of the vehicle, so the autonomous driving is effectively and safely performed.

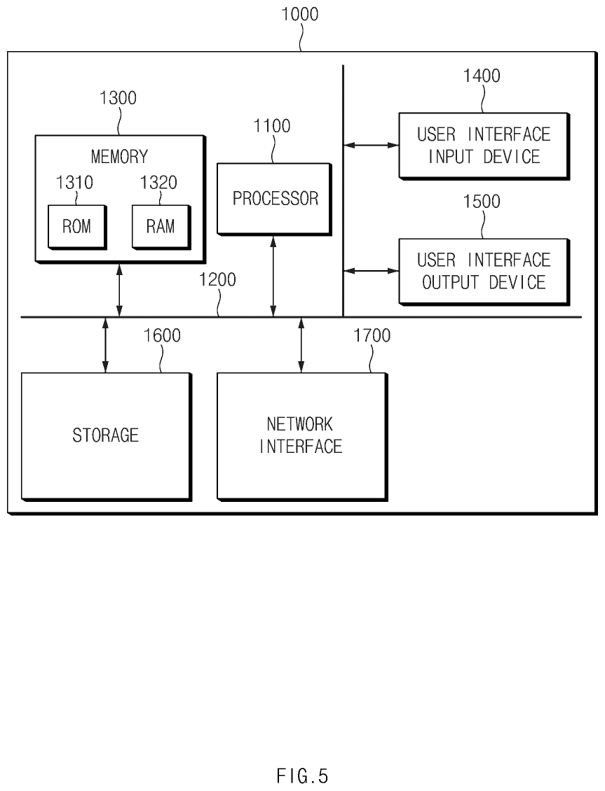

FIG. 5 is a block diagram illustrating a computing system in some forms of the present disclosure.

Referring to FIG. 5, a computing system 1000 may include at least one processor 1100, a memory 1300, a user interface input device 1400, a user interface output device 1500, a storage 1600, or a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in some forms of the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, the weigh of the autonomous vehicle may be estimated and reflected in vehicle control or the autonomous driving function is differently provided based on the weight of the autonomous vehicle, thereby improving the safety of the autonomous driving function.

Besides, a variety of effects directly or indirectly understood through the disclosure may be provided.

The description of the disclosure is merely exemplary in nature and, thus, variations that do not depart from the substance of the disclosure are intended to be within the scope of the disclosure. Such variations are not to be regarded as a departure form the spirit and scope of the disclosure.

What is claimed is:

1. An apparatus for controlling an autonomous vehicle, the apparatus comprising:
a processor configured to:
perform a control operation:
acquire a weight of the autonomous vehicle in real time; and
provide an autonomous driving function based on the weight of the autonomous vehicle; and
a storage to store the weight of the autonomous vehicle and information regarding the autonomous driving function corresponding to the weight of the autonomous vehicle.

2. The apparatus of claim 1, wherein the processor is configured to:
estimate the weight of the autonomous vehicle by measuring a suspension height.

3. The apparatus of claim 1, wherein the processor is configured to:
estimate the weight of the autonomous vehicle through vehicle dynamics calculation based on a vehicle acceleration, a vehicle speed, an engine torque, and an engine shaft angular speed.

4. The apparatus of claim 3, wherein the processor is configured to:
calculate driving force of the autonomous vehicle using the engine torque and the engine shaft angular speed; and
estimate the weight of the autonomous vehicle by using the driving force, a vehicle mass, the vehicle acceleration, an air resistance coefficient, and a rolling resistance.

5. The apparatus of claim 1, wherein the processor is configured to:
estimate the weight of the autonomous vehicle based on a braking distance resulting from a required deceleration of a vehicle.

6. The apparatus of claim 1, wherein the processor is configured to:
classify a grade of weight based on the weight of the autonomous vehicle and road frictions.

7. The apparatus of claim 1, wherein the processor is configured to:
perform the autonomous driving function by changing a control coefficient when the weight of the autonomous vehicle is equal to or less than a first predetermined value.

8. The apparatus of claim 7, wherein the processor is configured to:
perform the autonomous driving function limitedly when the weight of the autonomous vehicle is greater than the first predetermined value and less than a second predetermined value.

9. The apparatus of claim 8, wherein the processor is configured to:
perform at least one of lowering a maximum limit speed, increasing a distance from a front vehicle, deactivating a lane changing function, deactivating an overtaking function, or incresing a deceleration based on a road curvature to perform the autonomous driving function limitedly.

10. The apparatus of claim 8, wherein the processor is configured to:
deactivate the autonomous driving function when the weight of the autonomous vehicle is greater than the second predetermined value.

11. The apparatus of claim 10, wherein the processor is configured to:
transfer a control authority to a driver or control the autonomous driving function to lower a risk of danger is when the weight of the autonomous vehicle is greater than the second predetermined value.

12. A vehicle system comprising:
a sensor configured to sense information for estimating a weight of a vehicle; and
an autonomous vehicle controller configured to:
acquire the weight of the vehicle based on the information in real time; and
provide an autonomous driving function corresponding to the weight of the vehicle.

13. The vehicle system of claim 12, wherein the sensor further comprises:
a mass measurement sensor configured to measure the weight of the vehicle; and
a height measurement sensor configured to measure a suspension height of the vehicle.

14. The vehicle system of claim 12, wherein the autonomous vehicle controller is configured to:
estimate the weight of the vehicle based on a difference between a first suspension height that is measured when the vehicle is stopped and a second suspension height that is set when the vehicle is designed.

15. A method for controlling an autonomous vehicle, the method comprising:
acquiring a weight of the autonomous vehicle in real time; and
providing an autonomous driving function based on the weight of the autonomous vehicle.

16. The method of claim 15, wherein acquiring the weight of the autonomous vehicle in real time further comprises:
estimating the weight of the autonomous vehicle by measuring a suspension height or a braking distance resulting from a required deceleration of a vehicle.

17. The method of claim 16, wherein acquiring the weight of the autonomous vehicle in real time further comprises:
estimating the weight of the autonomous vehicle through vehicle dynamics calculation based on a vehicle acceleration, a vehicle speed, an engine torque, and an angular speed of an engine shaft.

18. The method of claim 16, wherein providing the autonomous driving function further comprises:
when the weight of the vehicle is equal to or less than a first predetermined value, performing the autonomous driving function by changing a control coefficient;
when the weight of the vehicle is greater than the first predetermined value and less than a second predetermined value, performing the autonomous driving function limitedly; and
when the weight of the vehicle is greater than the second predetermined value, deactivating the autonomous driving function.

19. The method of claim 17, wherein performing the autonomous driving function further comprises:
performing at least one of lowering a maximum limit speed, increasing a distance from a front vehicle, deactivating a lane changing function, deactivating an overtaking function, or incresing a deceleration based on a road curvature.
